(19) United States
(12) Patent Application Publication
(10) Pub. No.: US 2026/0243351 A1
(43) Pub. Date: Aug. 20, 2026

(54) High-pressure Valve and High-pressure Water Gun

(71) Applicant: SHANGHAI PEAKPOWER MANUFACTURING CO., LTD., Shanghai (CN)

(72) Inventor: JiangYong Gu, Shanghai (CN)

(21) Appl. No.: 19/649,087

(22) Filed: Apr. 15, 2026

Related U.S. Application Data
(62) Division of application No. 18/967,575, filed on Dec. 3, 2024.

(51) Int. Cl. F16K 1/14; B05B 7/02; B05B 9/01; F16K 1/52; F16K 39/02

(52) U.S. Cl. CPC F16K 1/14; B05B 7/02; B05B 9/01; F16K 1/52; F16K 39/02

(57) ABSTRACT

The invention relates to a high-pressure valve and a high-pressure water gun; the high-pressure water gun includes a high-pressure valve, which is provided with an adjusting cavity; and the adjusting cavity is provided with a buffer cavity and a pressure-reducing cavity; the buffer cavity is used to buffer air resistance; the pressure-reducing cavity is used to offset a pressure of high-pressure water. A User only needs to apply a small force to a wrench part of the high-pressure water gun, and then the user can switch on or off the high-pressure water gun.

### TECHNICAL FIELD

The invention belongs to the technical field of high-pressure cleaning, and particularly relates to a high-pressure valve and a high-pressure water gun.

### TECHNICAL BACKGROUND

When the existing high-pressure water gun is used for cleaning, the high pressure of the high-pressure water entering the high-pressure water gun impacts the valve core of the water outlet valve, so that the valve core closes the water outlet valve. Therefore, in order to keep the water outlet valve in the high-pressure water gun in an open state, the cleaning personnel need to hold the trigger vigorously all the time so that the driving force transmitted by the trigger to the valve core through the valve rod overcomes the high-pressure impact force of the high-pressure water on the valve core. When the cleaning personnel use the high-pressure water gun for a long time, the cleaning personnel's hands are prone to fatigue, and the longer the use time and the higher the water pressure sprayed by the high-pressure water gun, the more fatigued the cleaning personnel's hands become, even causing permanent damage to their hands.

### INVENTION CONTENT

In order to overcome the defects of the existing technology, the invention provides a high-pressure valve and a high-pressure water gun, wherein the high-pressure water gun comprises the high-pressure valve, so that the user only needs to apply a small force to the wrench part of the high-pressure water gun to switch on the high-pressure water gun, and the hands are not easily fatigued.

The technical scheme adopted by the invention for solving the technical problems is as follows:

A high-pressure valve, comprises a valve body, wherein the valve body further comprises a valve seat cavity, a valve rod cavity and an adjusting cavity; the valve rod cavity is arranged between the adjusting cavity and the valve seat cavity; the valve rod cavity is communicated with the valve seat cavity through a first communicating hole; the valve rod cavity is communicated with the adjusting cavity through a second communicating hole;

The valve body is also provided with a water inlet and a water outlet, wherein the water inlet is communicated with the valve seat cavity; the water outlet is communicated with the valve rod cavity; the valve seat cavity is internally provided with a valve core and an elastic piece; the valve core to move towards the first communicating hole under an elastic force from the elastic piece;

A valve rod is arranged in the valve rod cavity; two ends of the valve rod are respectively inserted into the first communicating hole and the second communicating hole; an adjusting assembly is arranged in the adjusting cavity; one end of the adjusting assembly is connected with the valve rod; an other end of the adjusting assembly extends to an outside of the valve body;

The adjusting assembly further comprises an adjusting head and an adjusting rod; the adjusting head is arranged at one end of the adjusting rod close to the valve rod; a radial section of the adjusting head is larger than that of the adjusting rod; the adjusting head divides the adjusting cavity into a pressure-reducing cavity and a buffer cavity; the pressure-reducing cavity locates at one side of the buffer cavity far away from the valve rod cavity; the pressure-reducing cavity is communicated with the water inlet or the water outlet; the buffer cavity is communicated with an external environment.

Furhter, the valve body is provided with a communicating pipe; the communicating pipe is used to communicate the pressure-reducing cavity with the water outlet.

Furhter, a first sealing plug is arranged at one end of the valve seat cavity away from the valve rod cavity; the first sealing plug is of a cylindrical structure; an opening is arranged at one end of the first sealing plug close to the valve rod cavity; an other end of the first sealing plug away from the valve rod cavity is closed; the elastic piece and a part of the valve core are arranged inside the first sealing plug; the first communicating hole and the first sealing plug share a same central axis line.

Further, the first sealing plug is connected with an inner wall of the valve body by a threading connection; a first sealing groove is arranged on an end of the first sealing plug close to the valve seat cavity; a first sealing ring is arranged in the first sealing groove.

Further, the valve seat cavity is provided with a valve seat; the valve seat locates at a side of the first communicating hole far away from the valve rod cavity; the valve seat and the first sealing plug is connected via a gap junction; an outer periphery of the valve seat is provided with a second sealing ring.

Furhter, a cylinder wall of the first sealing plug is provided with a communicating inlet; an aperture of the communicating inlet is smaller than an outer diameter of the valve core.

Further, a second sealing plug is arranged on one side of the adjusting cavity away from the valve rod cavity; the second sealing plug is provided with a mounting hole; the adjusting rod goes through the mounting hole; the adjusting cavity is further provided with an adjusting cylinder and a buffer stopper; the adjusting cylinder is arranged between the second sealing plug and the buffer stopper; the adjusting head is arranged inside the adjusting cylinder.

Further, the second sealing plug comprises a first part located at an end of the adjusting cavity and a second part inserted into the adjusting cavity; the second part is of a cylinder shape; an inner diameter of the second part is matched with an outer diameter of the adjusting cylinder; an end of the adjusting cylinder far away from the buffer stopper is inserted into the second part; a third sealing ring and a first washer are arranged between the end of the adjusting cylinder and the first part; the third sealing ring locates between the first sealing ring and the adjusting cylinder; the second part of the second sealing plug is provided with a fouth sealing ring.

Further, a sixth sealing ring and a second washer are arranged at a side of the buffer stopper far away from the adjusting cylinder; the sixth sealing ring and the second washer is sleeved on an outer periphery of the adjusting rod; the sixth sealing ring locates between the second communicating hole and the second washer.

The present invention also provides a high-pressure water gun, comprising a high-pressure valve as described above.

The beneficial effects of the present invention:

The invention provides a high-pressure valve and a high-pressure water gun, wherein the high-pressure water gun comprises a high-pressure valve; the high-pressure valve is provided with a pressure-reducing cavity and a buffer cavity; the buffer cavity is communicated with the atmosphere to buffer air resistance, and the pressure-reducing cavity is communicated with a water inlet to offset the pressure of high-pressure water in a valve seat cavity and a valve rod cavity, so that users only need to apply a small force to the wrench part of the high-pressure water gun to switch on the high-pressure water gun, solving the problem of hand fatigue that is prone to occur in the use of existing high-pressure water guns.

### Description of Figures

FIG. 1 is a schematic view of a valve body in the embodiment I of the present invention;

FIG. 2 is a sectional view of A-A in FIG. 1;

FIG. 3 is an overall schematic view of a high-pressure valve in the embodiment I of the present invention;

FIG. 4 is a sectional view of the high-pressure valve in the embodiment I of the present invention;

FIG. 5 is an overall schematic view of the internal structure of the high-pressure valve in the embodiment I of the present invention;

Description of marks in figures:

1. Valve body; 11. First communicating hole; 12. Second communicating hole; 13. Water inlet; 14. Water outlet; 15. First through hole; 16. Communicating pipe;

2. Valve seat cavity; 21. Valve core; 22. Elastic piece; 23. first sealing plug; 231. First sealing groove; 232. First sealing ring; 233. Communicating inlet; 24. Valve seat; 25. Second sealing ring;

3. Valve rod cavity; 31. Valve rod;

4. Adjusting cavity; 41. Pressure-reducing cavity; 42. Buffer cavity; 43. Adjusting assembly; 431. Adjusting head; 432. Adjusting rod; 44. second sealing plug; 441. Mounting hole; 442. First part; 443. Second part;

5. adjusting cylinder; 51. Buffer stopper; 511. Air vent; 52. Third sealing ring; 521. first washer; 53. fourth sealing ring; 54. Water inlet hole; 55. Second sealing groove; 551. Fifth sealing ring; 56. Sixth sealing ring; 561. Second washer.

### DETAILED DESCRIPTION OF THE EMBODIMENTS

Below is a further detailed description of the present invention based on the figures.

The present embodiment only shows an explanation of the present invention and it is not a limitation to the present invention. The skilled in the art can make modifications to this embodiment as needed without making any creative contributions after reading this specification, which are always protected by the patent law as long as they are within the scope of the claims of the present invention.

It should be noted that when an element is called as being “fixed to” or “arranged on” another element, it can be directly on the other element or indirectly on the other element. When an element is called as being “connected to” another element, it can be directly connected to the other element or indirectly connected to the other element.

It should be noticed that the terms “length”, “width”, “above”, “below”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present invention and simplifying the description, rather than indicating or implying that the device or component must have a specific orientation, construct and operate in a specific orientation, therefore, it understood as a limitation of the present invention.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present invention, “a plurality of” means two or more, unless otherwise specifically defined.

### Embodiment I

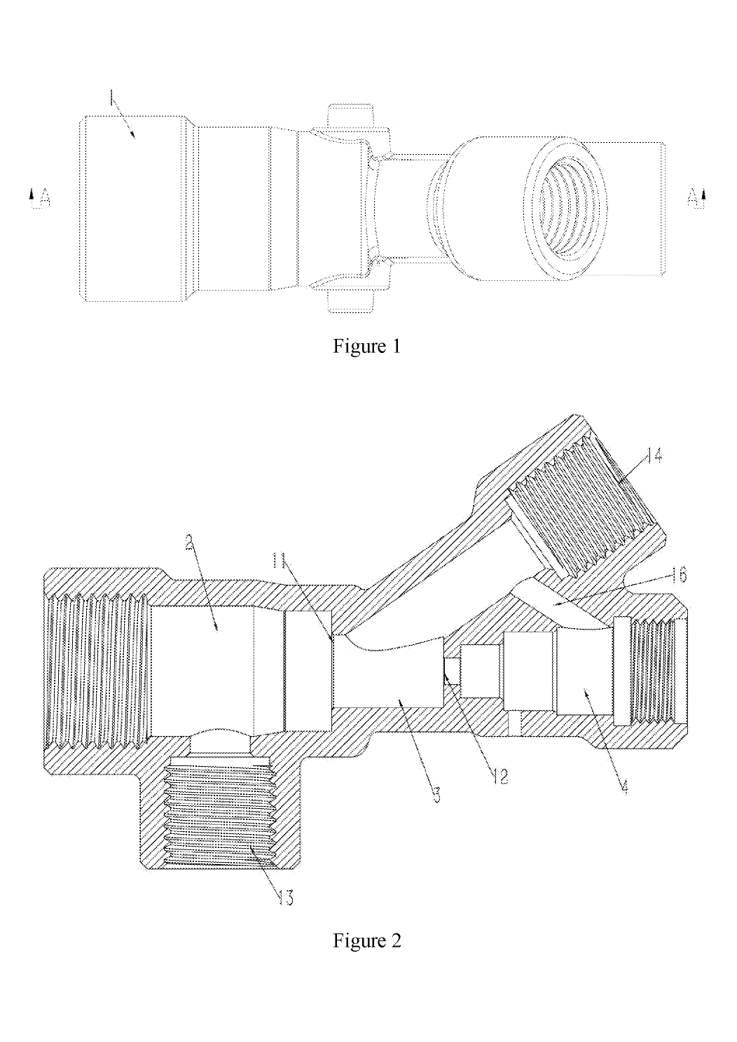

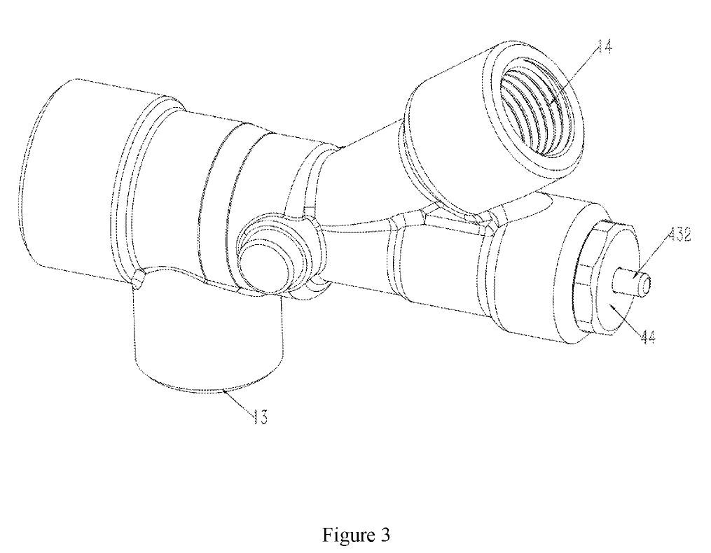

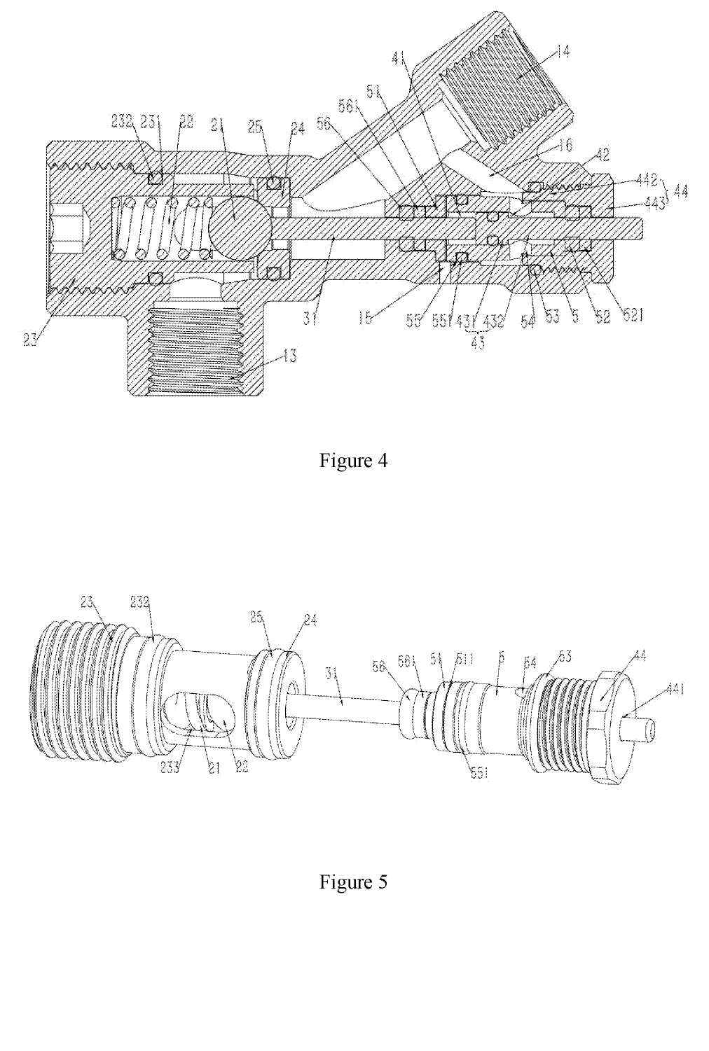

Referring to FIGS. 1-5, the embodiment provides a high-pressure valve, comprising a valve body 1, wherein the valve body 1 comprises a valve seat cavity 2, a valve rod cavity 3 and an adjusting cavity 4; the valve rod cavity 3 is arranged between the adjusting cavity 4 and the valve seat cavity 2; the valve rod cavity 3 is communicated with the valve seat cavity 2 through a first communicating hole 11; the valve rod cavity 3 is communicated with the adjusting cavity 4 through a second communicating hole 12.

The valve body 1 is also provided with a water inlet 13 and a water outlet 14; the water inlet 13 is communicated with the valve seat cavity 2; the water outlet 14 is communicated with the valve rod cavity 3; high-pressure water flow into the valve seat cavity 2 inside the valve body 1 along the water inlet 13; and then the high-pressure water flow into the valve rod cavity 3 through the first communicating hole 11 between the valve seat cavity 2 and the valve rod cavity 3; and finally the high-pressure water flow out from the water outlet 14.

The valve seat cavity 2 is internally provided with a valve core 21 and an elastic piece 22; the valve core 21 move towards the first communicating hole 11 under an elastic force from the elastic piece 22; the valve core 21 blocks the first communicating hole 11 to isolate the valve seat cavity 2 and the valve rod cavity 3; the high-pressure water in the valve seat cavity 2 fails to flow into the valve rod cavity 3.

The valve rod cavity 3 is provided with a valve rod 31; two ends of the valve rod 31 are respectively inserted into the first communicating hole 11 and the second communicating hole 12; an adjusting assembly 43 is arranged in the adjusting cavity 4; one end of the adjusting assembly 43 is connected with the valve rod 31, and an other end of the adjusting assembly 43 extends to an outside of the valve body 1.

The other end of the adjusting assembly 43 extending to the outside of the valve body 1 is used as a force application end; in other words, a user applies an external force on this one end to have the adjusting assembly 43 moved towards the valve rod cavity 3, and the valve rod 31 is driven to move towards the valve seat cavity 2; the one end of the valve rod 31 close to the valve seat cavity 2 pushes away the valve core 21 to block the first communicating hole 11, so that the valve seat cavity 2 is communicated with the valve rod cavity 3, thereby allowing the water inlet 13 to communicate with the water outlet 14.

The high-pressure water entering into the valve seat cavity 2 will generate an impact force on the valve core 21, resulting in that the valve core 21 moves toward the first communicating hole 11. Therefore, the user not only needs to overcome an impact force of the high-pressure water on the valve core 21, but also need to push the adjusting assembly 43 to move the valve rod 31, and then the user can have the valve seat cavity 2 and the valve rod cavity 3 in a communicated state.

Preferably, the adjusting assembly 43 comprises an adjusting head 431 and an adjusting rod 432; the adjusting head 431 is arranged at one end of the adjusting rod 432 close to the valve rod 31; a radial section of the adjusting head 431 is larger than that of the adjusting rod 432; the adjusting head 431 divides the adjusting cavity 4 into a pressure-reducing cavity 41 and a buffer cavity 42; the pressure-reducing cavity 41 locates at one side of the buffer cavity 3 far away from the valve rod cavity 42; the pressure-reducing cavity 41 is communicated with the water inlet 13; the buffer cavity 42 is communicated with an external environment. Specifically, the valve body 1 is provided with a first through hole 15; the buffer cavity 42 is communicated with the external environment through the first through hole 15.

Understandably, when the high-pressure water flows into the water inlet 13 of the high-pressure valve provided in this embodiment, some of the high-pressure water flows into the valve seat cavity 2; rest of the high-pressure water flows into the pressure-reducing cavity 41. When the user applies a force to the force application end of the adjusting assembly 43, the valve rod 31 pushes the valve core 21, so that the valve seat cavity 2 is communicated with the valve rod cavity 3, and the high-pressure water in the valve seat cavity 2 flows into the valve rod cavity 3; and then the high-pressure water sprays out along the water outlet 14. Since the water inlet 13, the valve rod cavity 3 and the pressure-reducing cavity 41 stay at a same water pressure, the user only need to overcome an air resistance generated by the air in the buffer cavity 42, in other words, it is much easier for the user to make the valve rod cavity 3 and the valve seat cavity 2 in communication; in specific, the user only need to push the valve core 21 to reset and block the first communicating hole 11, then the valve rod cavity 3 and the valve seat cavity 2 are in the communication state. It should be understood that a force pushing on the valve core 21 to reset and block the first communicating hole 11 refers to the elastic force from the elastic piece 22 applied on the valve core 21.

Preferably, the first sealing plug 23 is in threaded connection with an inner wall of the valve body 1; a first sealing groove 231 is arranged on a periphery end of the second sealing plug 23 close to the valve seat cavity 2; a first sealing ring 232 is arranged in the first sealing groove 231; thanks to the first sealing ring 232, the high-pressure water in the valve seat cavity 2 fails to flow out along a gap between the first sealing plug 23 and the inner wall of the valve body 1, thereby avoiding water leakage of the valve body 1.

Preferably, a valve seat 24 is arranged in the valve seat cavity 2; the valve seat 24 is arranged on one side of the first communicating hole 11 away from the valve rod cavity 3; a gap is reserved between the valve seat 24 and the second sealing plug 23; a second sealing ring 25 is sleeved on an outer periphery of the valve seat 24; when the high-pressure valve in the embodiment is in an open state, the high-pressure water comes from the water inlet 13, and then flows into the valve seat cavity 2, next flow to the valve rod cavity 3 along the gap between the valve seat 24 and the second sealing plug 23, also flow into the valve rod cavity 3 via the first communicating hole 11; the high-pressure water finally sprays out via the water outlet 14.

The valve seat 24 is arranged in the valve seat cavity 2; the valve seat 24 is used to protect the first communicating hole 11 in the valve body 1; thanks to the valve seat 24, the first communicating hole 11 avoids being directly attached by the valve core 21; furthermore, the high-pressure valve is water proof in a closed state because of the first communication hole 11 without being damaged; in addition, the second sealing ring 25 is sleeved on the outer periphery of the valve seat 24, which again improves a tightness between the valve seat cavity 2 and the valve rod cavity 3, in other words, no high-pressure water flows along the valve seat cavity 2 to the valve rod cavity 3 via the gap when the high-pressure valve in the closed state.

Further, a communicating inlet 233 is arranged on a cylinder wall of the second sealing plug 23; because of the communicating inlet 233, the high-presure waters from the water inlet 13 flows into valve seat cavity 2 at a smoother and higher speed.

Further, an aperture of the communicating inlet 233 is smaller than an outer diameter of the valve core 21; when the valve rod 31 pushed the valve core 21 to the second sealing plug 23, the valve core 21 will not fall into the water inlet 13 because of the aperture of the communicating inlet 233 smaller than an outer diameter of the valve core 21; what’s more, the water inlet 13 willl not be blocked by the valve core 21; in this way, the high-pressure water flows into the valve seat cavity 2 from the water inlet 13 smoothly.

Understandably, if the aperture of the communicating inlet 233 is larger than the outer diameter of the valve core 21, producers have to design the communicating inlet 233 and the water inlet 13 in a staggered form; only via the staggered form design, the valve core 21 will not fall into the water inlet 13 through the communicating inlet 233; however, this brings more assembly troublesome; while in the embodiment, the aperture of the communicating inlet 233 is smaller than outer diameter of the valve core 21, thus, the producers no need to consider whether the communicating inlet 233 is misaligned with the water inlet 13 during the production and assembly; it is simple and convenient for producer to assembly and produce rapidly in large amounts to save time and production cost.

Preferably, a second sealing plug 44 is arranged on one side of the adjusting cavity 4 far away from the valve rod cavity 3; the second sealing plug 44 is provided with a mounting hole 441; the adjusting rod 432 passes through the mounting hole 441; the adjusting cavity 4 is further provided with an adjusting cylinder 5 and a buffer stopper 51; the adjusting cylinder 5 is arranged between the second sealing plug 44 and the buffer stopper 51; the adjusting head 431 is arranged inside the adjusting cylinder 5; besides, a water inlet 54 is arranged on the adjusting cylinder 5; the water outlet 4 communicated with one end of the communicating pipe 16; an other end of the communicating pipe 16 communicates with the water inlet 54.

The second sealing plug 44 comprises a first part 442 and a second part 443; the first part 442 locates at the end of the adjusting cavity 4; the second part 443 inserts into the adjusting cavity 4; the second part 443 is of a cylinder shape; an inner diameter of the second part 443 is matched with an outer diameter of the adjusting cylinder 5; an end of the adjusting cylinder 5 far away from the buffer stopper 51 is inserted into the second part 443.

A third sealing ring 52 and a first washer 521 are arranged between the end of the adjusting cylinder 5 and the first part 442; the third sealing ring 52 locates between the first washer 521 and the adjusting cylinder 5; thanks to such arrangement, the high-pressure water in the adjusting cylinder 5 will not directly rush in the second sealing plug 44, thereby improving water proof effect between the second sealing plug 44 and the valve body 1.

Further, the second part 443 of the second sealing plug 44 is provided with a fourth sealing ring 53; the fourth sealing ring 53 is used to seal the gap between the inner wall of the valve body 1 and the second part 443, so as to prevent the high-pressure water in the pressure-reducing cavity 41 from flowing out along the gap between the second sealing plug 44 and the inner wall of the valve body 1.

Furhter, a second sealing groove 55 is arranged on the periphery of the adjusting cylinder 5; the second sealing groove 55 is provided with a fifth sealing ring 551; the fifth sealing ring 551 is used to block communication betweeen the pressure-reducing cavity 41 and the buffer cavity 42, thereby avoiding the high-pressure water in the pressure-reducing cavity 41 directly rushing in the buffer cavity 42.

Further, the buffer stopper 51 is provided with an air vent 511; air in the buffer cavity 42 goes out the valve body 1 via a gap between the buffer stopper 51 and the adjusting cylinder 5, or via the air vent 511, or via the first through hole 15. As a result, a press force on the adjusting head 431 from the air in the buffer cavity 42 remains the same, in other words, the user only need to overcome the elastic force from the elastic piece 22, then the user can push the valve core 21 to have the high-pressure valve opened, thereby making the water inlet 13 in communication with the water outlet 14. When the air in the buffer cavity 42 completely goes out or when the adjusting head 431 contacts with a surface of the buffer stopper 51, the high-pressure valve is opened.

Further, a sixth sealing ring 56 and a second washer 561 are arranged at a side of the buffer stopper 51 far away from the adjusting cylinder 5; the sixth sealing ring 56 and the second washer 561 are sleeved on an outer periphery of the adjusting rod 432; the sixth sealing ring 56 locates between the second communicating hole 12 and the second washer 561; the sixth sealing ring 56 is used to seal the second communicating hole 12; when the high-pressire valve is closed, the high-pressure water in the valve rod cavity 3 can not flow into the adjusting cavity 4 via the second communicating hole 12, thereby avoiding water leakage; the second washer 561 is used to fix the sixth sealing ring 56; thanks to the second washer 561, the sixth sealing ring 56 will not move along the valve rod 31, in this way, it improves the water proof effect of the second communicating hole 12.

The embodiment also provides a high-pressure water gun, which includes the high-pressure valve provided by the embodiment.

When the high-pressure valve provided by the embodiment is used and install in the high-pressure water gun, the force application end of the adjusting assembly 43 corresponds to a wrench part of the high-pressure water gun; the water inlet 13 corresponds to the water inlet of the high-pressure water gun; the water outlet 14 corresponds to a nozzle of the high-pressure water gun; the user press the wrench part of the high-pressure water gun so as to drive the valve rod 31 to move the valve core 21, so that the valve seat cavity 2 is communicated with the valve rod cavity 3, then the high-pressure water flows through the valve seat cavity 2, and then reaches to the valve rod cavity 3, finally the high-pressure water sprays out via the nozzle of the high-pressure water gun.

According to the description above, the user only need to slightly press the wrench part of the high-pressure water gun, then the valve rod 31 will lead the valve core 21 to move, thereby making the valve seat cavity 2 in communication with the valve rod cavity 3; it is easiler and convenient for the user to use the high-pressure water gun; such simple operation with little work brings the user with a conformtable use experience as well.

It could be understood that under the guidance of the above embodiments, those skilled in the filed can combine various implementation methods in the above embodiments to obtain technical solutions of multiple implementation methods.

The above description is only a preferred embodiment of the present application and is not to limit the present utility patent. Any modifications, equivalent substitutions and improvements made within the spirit and principles of the present application should be included in the protection scope of the present application.

1. A high-pressure valve, comprises a valve body,
wherein the valve body comprises a valve seat cavity, a valve rod cavity and an adjusting cavity; the valve rod cavity is arranged between the adjusting cavity and the valve seat cavity; the valve rod cavity is communicated with the valve seat cavity through a first communicating hole; the valve rod cavity is communicated with the adjusting cavity through a second communicating hole;
wherein the valve body is also provided with a water inlet and a water outlet; the water inlet is communicated with the valve seat cavity; the water outlet is communicated with the valve rod cavity;
wherein the valve seat cavity is internally provided with a valve core and an elastic piece; the valve core moves towards the first communicating hole under an elastic force from the elastic piece;
wherein a valve rod is arranged in the valve rod cavity; two ends of the valve rod respectively insert into the first communicating hole and the second communicating hole; an adjusting assembly is arranged in the adjusting cavity; one end of the adjusting assembly is connected with the valve rod, and an other end of the adjusting assembly extends to an outside of the valve body;
wherein the adjusting assembly further comprises an adjusting head and an adjusting rod; the adjusting head is arranged at one end of the adjusting rod close to the valve rod; a radial section of the adjusting head is larger than that of the adjusting rod; the adjusting head divides the adjusting cavity into a pressure-reducing cavity and a buffer cavity; the pressure-reducing cavity locates at a side of the buffer cavity far away from the valve rod cavity; the pressure-reducing cavity is communicated with the water inlet or the water outlet; the buffer cavity is communicated with an external environment.

2. The high-pressure valve according to claim 1, wherein a communicating pipe is arranged in the valve body; the communicating pipe is used to communicate the pressure-reducing cavity with the water outlet.

3. The high-pressure valve according to claim 1, wherein a first sealing plug is arranged at one end of the valve seat cavity away from the valve rod cavity; the first sealing plug is of a cylindrical structure; one end of the first sealing plug close to the valve rod cavity is open, while an other end of the first sealing plug away from the valve rod cavity is close; the elastic piece and a part of the valve core are arranged inside the first sealing plug; the first communicating hole and the first sealing plug share a same central axis line.

4. The high-pressure valve according to claim 3, wherein the first sealing plug is connected with an inner wall of the valve body by a threading connection; a first sealing groove is arranged on an end of the first sealing plug close to the valve seat cavity; a first sealing ring is arranged in the first sealing groove.

5. The high-pressure valve according to claim 3, wherein the valve seat cavity is provided with a valve seat; the valve seat locates at a side of the first communicating hole far away from the valve rod cavity; the valve seat and the first sealing plug is connected via a gap junction; an outer periphery of the valve seat is provided with a second sealing ring.

6. The high-pressure valve according to claim 3, wherein a cylinder wall of the first sealing plug is provided with a communicating inlet; an aperture of the communicating inlet is smaller than an outer diameter of the valve core.

7. The high-pressure valve according to claim 1, wherein a second sealing plug is arranged on one side of the adjusting cavity away from the valve rod cavity; the second sealing plug is provided with a mounting hole; the adjusting rod goes through the mounting hole; the adjusting cavity is further provided with an adjusting cylinder and a buffer stopper; the adjusting cylinder is arranged between the second sealing plug and the buffer stopper; the adjusting head is arranged inside the adjusting cylinder.

8. The high-pressure valve according to claim 7, wherein the second sealing plug comprises a first part and a second part; the first part locates at an end of the adjusting cavity; the second part inserts into the adjusting cavity; the second part is of a cylinder shape; an inner diameter of the second part is matched with an outer diameter of the adjusting cylinder; an end of the adjusting cylinder far away from the buffer stopper is inserted into the second part; a third sealing ring and a first washer are arranged between the end of the adjusting cylinder and the first part; the third sealing ring locates between the first washer and the adjusting cylinder; the second part of the second sealing plug is provided with a fouth sealing ring.

9. The high-pressure valve according to claim 7, wherein a sixth sealing ring and a second washer are arranged at a side of the buffer stopper far away from the adjusting cylinder; the sixth sealing ring and the second washer are sleeved on an outer periphery of the adjusting rod; the sixth sealing ring locates between the second communicating hole and the second washer.

10. A high-pressure water gun, comprises the high-pressure valve described in claim 1.

11. A high-pressure water gun, comprises the high-pressure valve according to claim 2.

12. A high-pressure water gun, comprises the high-pressure valve according to claim 3.

13. A high-pressure water gun, comprises the high-pressure valve according to claim 4.

14. A high-pressure water gun, comprises the high-pressure valve according to claim 5.

15. A high-pressure water gun, comprises the high-pressure valve according to claim 6.

16. A high-pressure water gun, comprises the high-pressure valve according to claim 7.

17. A high-pressure water gun, comprises the high-pressure valve according to claim 8.

18. A high-pressure water gun, comprises the high-pressure valve according to claim 9.
